(19) United States
(12) Patent Application Publication
(10) Pub. No.: US 2010/0274530 A1
(43) Pub. Date: Oct. 28, 2010

(54) SYSTEM AND METHOD FOR ANALYZING A USAGE RATE OF A CENTRAL PROCESSING UNIT IN A MOBILE DEVICE

(75) Inventor: CHI-HSIEN CHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/538,981

(22) Filed: Aug. 11, 2009

(30) Foreign Application Priority Data
Apr. 28, 2009 (CN) 200910301930.X

(51) Int. Cl. G06F 15/00; G06F 9/46

(52) U.S. Cl. 702/186; 718/102

(57) ABSTRACT

A central processing unit (CPU) analyzing method sets a time interval and a time period for analyzing a usage rate of the CPU, reads a current time of a hardware timer in a mobile device when a thread is suspended, calculates a CPU time used by the suspended thread. The method further calculates an average time used by each thread during the time period, and divides the average time by the time period so as to obtain the usage rate of the CPU in the mobile device.

### BACKGROUND

1. Technical Field

Embodiments of the present disclosure relate to mobile device management, and particularly to a system and method for analyzing a usage rate of a central processing unit (CPU) in a mobile device.

2. Description of Related Art

Mobile phones may comprise one or more processors to execute one or more functions for an operating system and programs of the mobile phones. A software timer may be implemented in a mobile phone to simulate a usage rate of a processor in the mobile phone. However, current software timers may not reliably simulate usage rate of a processor in a mobile phone.

### BRIEF DESCRIPTION OF THE DRAWINGS

FIG. 1 is a schematic diagram of one embodiment of a mobile device comprising a CPU analyzing system;

FIG. 2 is a block diagram of one embodiment of the CPU analyzing system shown in FIG. 1; and

FIG. 3 is a flowchart of one embodiment of a method for analyzing a usage rate of a CPU in the mobile device.

### DETAILED DESCRIPTION

All of the processes described below may be embodied in, and fully automated via, functional code modules executed by one or more general purpose mobile devices or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

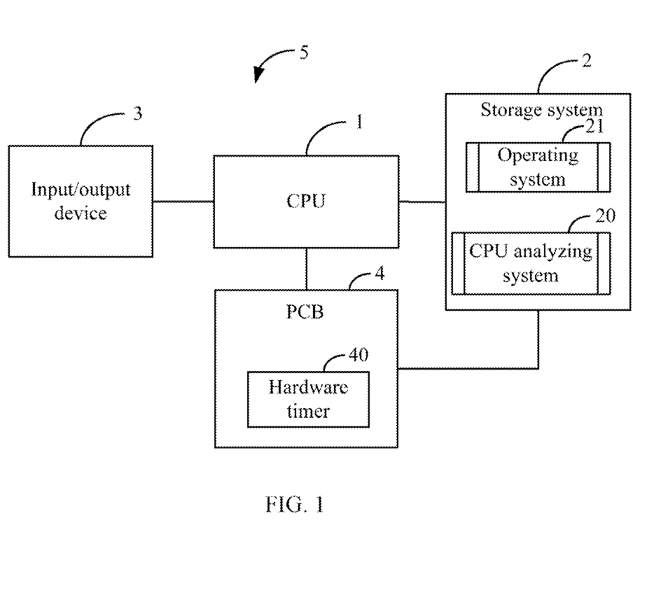

FIG. 1 is a schematic diagram of one embodiment of a mobile device 5 comprising a central processing unit (CPU) analyzing system 20. The CPU analyzing system 20 may be used to calculate an average time used by each thread executed in the CPU 20 during a preset time period using a hardware timer 40. The CPU analyzing system 20 may then divide the average time by the preset time period so as to obtain a usage rate of a CPU 1 in the mobile device 5. In one embodiment, the hardware timer 40 may be a watchdog timer.

In one embodiment, the mobile device 5 includes the CPU 1, a storage system 2, an input/output device 3, and a printed circuit board (PCB) 4. The CPU 1 is electronically connected to the storage system 2, the input/output device 3, and the PCB 4. The PCB 4 is connected to the storage system 2. In one embodiment, the mobile device 5 may be a cell phone, a digital camera, or a personal digital assistant (PDA), for example.

In one embodiment, the storage system 2 stores computerized codes of the CPU analyzing system 20 and an operating system 21. The CPU 1 controls execution of the computerized codes of the CPU analyzing system 20 and the operating system 21. The operating system 21 is operable to call a scheduler of the mobile device 5 to select a next thread to execute when a current thread is suspended. In one embodiment, the storage system 2 may be a flash memory, and the input/output device 3 may include a liquid crystal display (LCD) and a keyboard, but the disclosure is not limited thereto.

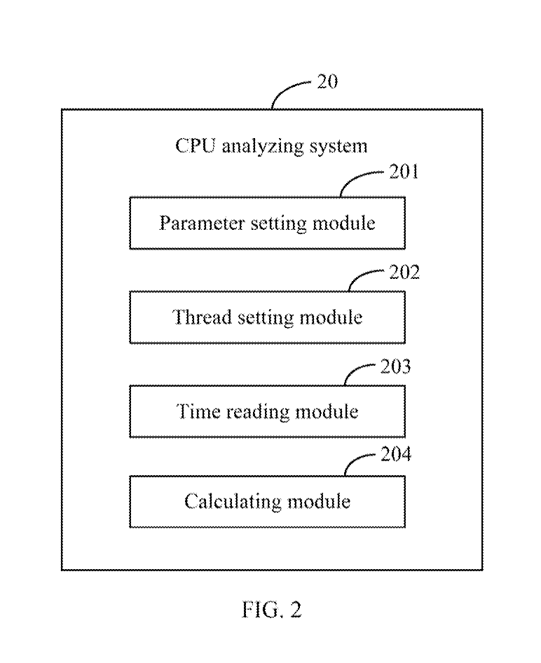

FIG. 2 is a block diagram of one embodiment of the CPU analyzing system 20 in FIG. 1. In one embodiment, the CPU analyzing system 20 includes a parameter setting module 201, a thread setting module 202, a time reading module 203, and a calculating module 204.

The parameter setting module 201 sets a time interval (e.g., 120 seconds) and a time period (e.g., 100 seconds) for analyzing the usage rate of the CPU 1 in the mobile device 5. Then, the CPU analyzing system 20 executes an analysis process every set time interval to analyze the usage rate of the CPU 1 in 100 seconds. In one embodiment, the time period is less than or equal to the time interval.

The thread setting module 202 creates an idle thread, and makes the idle thread run in an infinite loop so as to prevent the operating system 21 from entering a sleep mode. In one embodiment, the idle thread is a current thread having a lowest priority in the mobile device 5.

The time reading module 203 reads a current time of a hardware timer 40 in the mobile device 5 when a thread is suspended during a time period, calls a scheduler of the mobile device 5 by the operating system 21 to select a next thread to execute, and sets a maximum value of the current time of the hardware timer 40. In one embodiment, the current time of the hardware timer 40 is read from a register of the hardware timer 40, and the maximum value of the hardware timer 40 is 0xFFFF. A thread is suspend when one of following situations occurs: (1) the thread ends; (2) an interrupt occurs while the thread is running; (3) the thread releases a semaphore signal while running. The semaphore signal represents that a thread having a higher priority needs to be executed, so the current thread is needed to be suspended.

The calculating module 204 calculates a CPU time used by the suspended thread, and stores a used CPU time in an array. In one embodiment, the CPU time used by the suspended thread equals to a difference between the maximum value of the hardware timer 40 and the current time of the hardware timer 40. In other embodiment, the used CPU time may be stored in a queue or other suitable data structure.

The calculating module 204 further calculates the usage rate of the CPU 1 based on values in the array when the time period runs out. A detailed description is as follows. Firstly, the calculating module 204 totals each used CPU time in the array to obtain a total CPU time. Secondly, the calculating module 204 divides the total CPU time by a count of the used CPU time in the array to obtain an average time used by each thread during the time period. Thirdly, the calculating module 204 divides the average time by the time period to obtain the usage rate of the CPU 1 during the time period in the mobile device 5.

For example, supposing thread A, thread B, and thread C are executed by the CPU 1 during a time period, and a CPU time used by the thread A is 30 seconds, a CPU time used by the thread B is 40 seconds, a CPU time used by the thread C is 50 seconds, and the time period is 100 seconds. Thus, an average time used by the threads A, B, and C during the time period is: (30 s+40 s+50 s)/3 s=40 s, and the usage rate of the CPU 1 during the time period is: 40 s/100 s=40%.

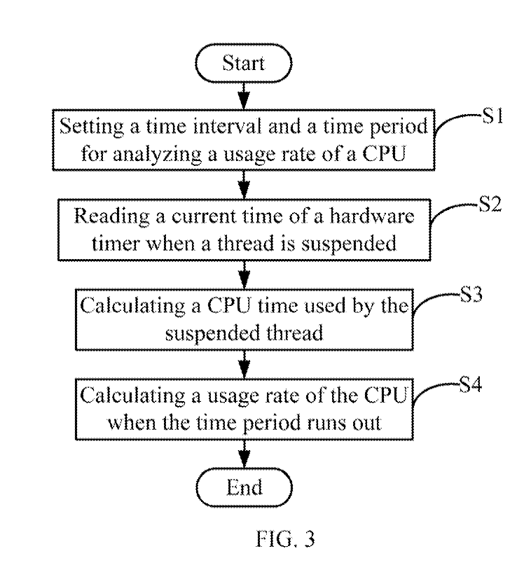

FIG. 3 is a flowchart of one embodiment of a method for analyzing a usage rate of the CPU 1 in the mobile device 5. Depending on the embodiment, additional blocks may be added, others removed, and the ordering of the blocks may be changed.

In block S1, the parameter setting module 201 sets a time interval (e.g., 60 seconds) and a time period (e.g., 30 seconds) for analyzing the usage rate of the CPU 1 in the mobile device 5. In one embodiment, the time period is less than or equal to the time interval.

In block S2, the time reading module 203 reads a current time of a hardware timer 40 in the mobile device 5 when a thread is suspended during a time period, calls a scheduler of the mobile device 5 by the operating system 21 to select a next thread to execute, and sets a maximum value of the current time of the hardware timer 40. In one embodiment, the current time of the hardware timer 40 is read from a register of the hardware timer 40, and the maximum value of the hardware timer 40 is 0xFFFF.

In block S3, the calculating module 204 calculates a CPU time used by the suspended thread, and stores a used CPU time in an array. In one embodiment, the CPU time used by the suspended thread equals to a difference between the maximum value of the hardware timer 40 and the current time of the hardware timer 40.

In block S4, the calculating module 204 calculates the usage rate of the CPU 1 based on values in the array when the time period runs out. A detailed description is as follows.

Firstly, the calculating module 204 totals each used CPU time in the array to obtain a total CPU time. Secondly, the calculating module 204 divides the total CPU time by a count of the used CPU time in the array to obtain an average time used by each thread during the time period. Thirdly, the calculating module 204 divides the average time by the time period to obtain the usage rate of the CPU 1 during the time period in the mobile device 5.

In other embodiment, the method further includes a step of: creating an idle thread, and making the idle thread run in an infinite loop so as to prevent the operating system 21 from entering a sleep mode. For example, the idle thread is a current thread having a lowest priority in the mobile device 5.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for analyzing a usage rate of a central processing unit (CPU) in a mobile device, the method comprising:
setting a time interval and a time period for analyzing the usage rate of the CPU in the mobile device;
reading a current time of a hardware timer in the mobile device when a thread executed by the CPU is suspended during the time period, calling a scheduler of the mobile device to select a next thread to execute, and setting a maximum value of the current time of the hardware timer;
calculating a CPU time used by the suspended thread, and storing a used CPU time in an array, wherein the CPU time used by the suspended thread equals to a difference between the maximum value of the hardware timer and the current time of the hardware timer; and
calculating the usage rate of the CPU during the time period based on values in the array when the time period runs out.

2. The method according to claim 1, further comprising: creating an idle thread, and making the idle thread run in an infinite loop.

3. The method according to claim 2, wherein the idle thread is a current thread having a lowest priority in the mobile device.

4. The method according to claim 1, wherein the thread is suspended when one of followed situations occurs
the thread ends;
an interrupt occurs while the thread is running; or
the thread releases a semaphore signal while running.

5. The method according to claim 1, wherein the current time of the hardware timer is read from a register of the hardware timer.

6. The method according to claim 1, wherein calculating the usage rate of the CPU based on values in the array comprises:
totaling each used CPU time in the array to obtain a total CPU time;
dividing the total CPU time by a count of the used CPU time in the array to obtain an average time used by each thread during the time period; and
dividing the average time by the time period to obtain the usage rate of the CPU during the time period in the mobile device.

7. The method according to claim 1, wherein the mobile device is selected from the group consisting of a cell phone, a digital camera, and a personal digital assistant (PDA).

8. A storage medium having stored thereon instructions that, when executed by a processor of a mobile device, causes the processor to perform a method for analyzing a usage rate of a central processing unit (CPU) in a mobile device, the method comprising:
setting a time interval and a time period for analyzing the usage rate of the CPU in the mobile device;
reading a current time of a hardware timer in the mobile device when a thread executed by the CPU is suspended during the time period, calling a scheduler of the mobile device to select a next thread to execute, and setting a maximum value of the current time of the hardware timer;
calculating a CPU time used by the suspended thread, and storing a used CPU time in an array, wherein the CPU time used by the suspended thread equals to a difference between the maximum value of the hardware timer and the current time of the hardware timer; and
calculating the usage rate of the CPU during the time period based on values in the array when the time period runs out.

9. The storage medium according to claim 8, wherein the method further includes:
creating an idle thread, and making the idle thread run in an infinite loop.

10. The storage medium according to claim 9, wherein the idle thread is a current thread having a lowest priority in the mobile device.

11. The storage medium according to claim 8, wherein the thread is suspended when one of followed situations occurs:
the thread ends;
an interrupt occurs while the thread is running; or
the thread releases a semaphore signal while running.

12. The storage medium according to claim 8, wherein the current time of the hardware timer is read from a register of the hardware timer.

13. The storage medium according to claim 8, wherein calculating the usage rate of the CPU based on values in the array comprises:
totaling each used CPU time in the array to obtain a total CPU time;
dividing the total CPU time by a count of the used CPU time in the array to obtain an average time used by each thread during the time period; and
dividing the average time by the time period to obtain the usage rate of the CPU during the time period in the mobile device.

14. A system for analyzing a usage rate of a central processing unit (CPU) in a mobile device, comprising:
a parameter setting module operable to set a time interval and a time period for analyzing the usage rate of the CPU in the mobile device;
a time reading module operable to read a current time of a hardware timer in the mobile device when a thread executed by the CPU is suspended during the time period, call a scheduler of the mobile device to select a next thread to execute, and set a maximum value of the current time of the hardware timer;
a calculating module operable to calculate a CPU time used by the suspended thread, and store a used CPU time in an array, wherein the CPU time used by the suspended thread equals to a difference between the maximum value of the hardware timer and the current time of the hardware timer; and
the calculating module further operable to calculate the usage rate of the CPU during the time period based on values in the array when the time period runs out.

15. The system according to claim 14, further comprising:
a thread setting module operable to create an idle thread, and making the idle thread run in an infinite loop.

16. The system according to claim 15, wherein the idle thread is a current thread having a lowest priority in the mobile device.

17. The system according to claim 14, wherein the thread is suspend when one of followed situations occurs:
the thread ends;
an interrupt occurs while the thread is running; or
the thread releases a semaphore signal while running.

18. The system according to claim 14, wherein the current time of the hardware timer is read from a register of the hardware timer.

19. The system according to claim 14, wherein the maximum value of the hardware timer is 0xFFFF.

20. The system according to claim 14, wherein the calculating module calculates the usage rate of the CPU based on values in the array includes the followed steps:
totaling each used CPU time in the array to obtain a total CPU time;
dividing the total CPU time by a count of the used CPU time in the array to obtain an average time used by each thread during the time period; and
dividing the average time by the time period to obtain the usage rate of the CPU during the time period in the mobile device.
